(19) United States
(12) Patent Application Publication
(10) Pub. No.: US 2026/0000069 A1
(43) Pub. Date: Jan. 1, 2026

(54) PLATFORM ASSEMBLY FOR ATTACHMENT TO A TREE

(71) Applicant: Latitude Outdoors, LLC, Grand Rapids, MI (US)

(72) Inventors: Kevin Leach, Grand Rapids, MI (US); Alex Chopp, Royal Oak, MI (US); Jake Matelic, Royal Oak, MI (US)

(73) Assignee: Latitude Outdoors, LLC, Grand Rapids, MI (US)

(21) Appl. No.: 19/247,312

(22) Filed: Jun. 24, 2025

Related U.S. Application Data
(60) Provisional application No. 63/665,590, filed on Jun. 28, 2024.

(51) Int. Cl. A01M 31/02

(52) U.S. Cl. CPC A01M 31/02

(57) ABSTRACT

A platform assembly includes a platform. The platform has an outer perimeter that bounds an interior structure that defines a receiving area. The platform includes an upper surface for supporting feet of a user. The upper surface defines an upper plane of the platform. A post is pivotably coupled with the platform and is operable to pivot between the stowed position, wherein the post is received within the receiving area, and the deployed position. Standoff is pivotably coupled with the post and is operable to pivot relative to the post between the retracted position and the use position. In the stowed position of the post and the retracted position of the standoff, no portion of the standoff and no portion of the post is positioned upward of the upper plane of the platform.

### CROSS-REFERENCE TO RELATED APPLICATIONS

This application claims priority to and the benefit under 35 U.S.C. § 119 (e) of U.S. Provisional Patent Application No. 63/665,590, filed Jun. 28, 2024, entitled PLATFORM ASSEMBLY FOR ATTACHMENT TO A TREE, the entire disclosure of which is hereby incorporated herein by reference.

### FIELD OF THE DISCLOSURE

The present disclosure generally relates to a platform assembly for attachment to a tree. More specifically, the present disclosure relates to a platform assembly having a stowable post and standoff.

### BACKGROUND OF THE DISCLOSURE

Tree stand platforms are often used for hunting.

### SUMMARY OF THE DISCLOSURE

According to a first aspect of the present disclosure, a platform assembly includes a platform having an outer perimeter that bounds an interior structure that defines a receiving area, the platform having an upper surface for supporting feet of a user, wherein the upper surface defines an upper plane of the platform. A post is pivotably coupled to the platform and operable to pivot between a stowed position, wherein the post is received within the receiving area, and a deployed position. A standoff is pivotably coupled to the post and operable to pivot relative to the post between a retracted position and a use position, wherein, in the stowed position of the post and the retracted position of the standoff, no portion of the standoff is positioned upward of the upper plane of the platform.

Embodiments of the first aspect of the disclosure can include any one or a combination of the following features:
a component that is distinct from the post, coupled to the post, and configured to pivot with the post between the stowed position and the deployed position, wherein, in the stowed position of the post, the component protrudes upward of the upper plane of the platform;
a threaded shaft that is coupled to the post and to an adjustment knob, such that rotation of the adjustment knob adjusts a distance that the threaded shaft extends outward from the post;
a pivot pin that extends through a portion of the platform and extends through the post to allow the post to pivot relative to the platform about the pivot pin, wherein the platform includes a plurality of teeth that are configured to engage a tree, and wherein the pivot pin is positioned vertically lower than a portion of at least one of the plurality of teeth;
the upper surface of the platform includes a rear portion that defines the upper plane and a front portion that angles downward as the front portion extends forward from the rear portion of the upper surface toward a front of the platform, such that the front portion of the upper surface extends below the upper plane at an angle relative to the upper plane, and wherein, in the stowed position of the post and the retracted position of the standoff, a first portion of the standoff is aligned, with respect to the forward-rearward directions, with the rear portion of the upper surface, and a second portion of the standoff is aligned, with respect to the forward-rearward direction, with the front portion of the upper surface;
an insert that is configured to be engaged with the platform and includes opposing first and second lateral wings, wherein a portion of the post is disposed between the first and second lateral wings and a pivot pin that extends through the platform, the first and second lateral wings, and the portion of the post, wherein the pivot pin is configured to allow pivotal movement of the post relative to the insert and the platform between the stowed and deployed positions;
the first lateral wing of the insert includes an interior side surface that faces laterally-inboard toward the post, the second lateral wing of the insert includes an interior side surface that faces laterally-inboard toward the post, and the interior side surface of the first lateral wing is substantially parallel to the interior side surface of the second lateral wing when the insert is engaged with the platform;
the interior structure of the platform that defines the receiving area includes opposing first and second laterally-inboard facing surfaces, at least a portion of the first laterally-inboard facing surface angles radially inboard as the at least a portion of the first laterally-inboard facing surface extends downward, and at least a portion of the second laterally-inboard facing surface angles radially inboard as the at least a portion of the second laterally-inboard facing surface extends downward;
the first lateral wing of the insert includes a laterally-outboard facing surface and the second lateral wing of the insert includes a laterally-outboard facing surface, and wherein the laterally-outboard facing surfaces of the first and second lateral wings are angled to complement the angles of the first and second laterally-inboard facing surfaces of the portion of the interior structure of the platform, respectively;
threaded shaft that is coupled to the post and to an adjustment knob, such that rotation of the adjustment knob adjusts a distance that the threaded shaft extends outward from the post, which determines the angle of the post relative to the platform in the deployed position of the post due to contact between a head of the threaded shaft and a rear sloped portion that extends laterally between the first and second lateral wings of the insert; and
at least a portion of the adjustment knob is positioned upward of the upper plane defined by the upper surface of the platform in the deployed position of the post.

According to a second aspect of the present disclosure, a platform assembly includes a platform having an outer perimeter that bounds an interior structure that defines a receiving area. An insert is engaged with the platform and that includes opposing first and second lateral wings that extend within the receiving area defined by the interior structure of the platform. a post extends within the receiving area laterally between the first and second lateral wings of the insert. A pivot pin extends through the platform, the post, and the first and second lateral wings of the insert, wherein the pivot pin allows the post to pivot relative to the platform between a stowed position and a deployed position.

Embodiments of the second aspect of the disclosure can include any one or a combination of the following features:
the first lateral wing of the insert includes an interior side surface that faces laterally-inboard toward the post, the second lateral wing of the insert includes an interior side surface that faces laterally-inboard toward the post, and the interior side surface of the first lateral wing is substantially parallel to the interior side surface of the second lateral wing when the insert is engaged with the platform;
a portion of the interior structure of the platform that defines the receiving area includes opposing first and second laterally-inboard facing surfaces, at least a portion of the first laterally-inboard facing surface angles laterally inboard as the at least a portion of the first laterally-inboard facing surface extends downward, and at least a portion of the second laterally-inboard facing surface angles laterally inboard as the at least a portion of the second laterally-inboard facing surface extends downward;
the first lateral wing of the insert includes a laterally-outboard facing surface and the second lateral wing of the insert includes a laterally-outboard facing surface, and wherein the laterally-outboard facing surfaces of the first and second lateral wings are angled to complement the angles of the first and second laterally-inboard facing surfaces of the portion of the interior structure of the platform, respectively;
a standoff that extends outward from the post;
the standoff is a standoff pivotably coupled with the post and operable to pivot relative to the post between a retracted position and a use position; and
the platform includes an upper surface that defines an upper plane of the platform, and, in the stowed position of the post and the retracted position of the standoff, the upper plane is positioned upward of the post and the standoff.

According to the third aspect of the disclosure, a platform assembly includes a platform having an outer perimeter that bounds an interior structure that defines a receiving area, the platform having an upper surface for supporting feet of a user, wherein the upper surface defines an upper plane of the platform. An insert is engaged with the platform and that includes opposing first and second lateral wings that extend within the receiving area defined by the interior structure of the platform. A post extends within the receiving area laterally between the first and second lateral wings of the insert. A standoff is pivotably coupled with the post and operable to pivot relative to the post between a retracted position and a use position. A pivot pin extends through the platform, the post, and the first and second lateral wings of the insert, wherein the pivot pin allows the post to pivot relative to the platform between a stowed position, in which the post is received within the receiving area, and a deployed position, and wherein, in the stowed position of the post and the retracted position of the standoff, no portion of the post and no portion of the standoff is positioned upward of the upper plane of the platform.

Embodiments of the third aspect of the disclosure can include the following feature:
a component that is distinct from the post, coupled to the post, and configured to pivot with the post between the stowed position and the deployed position, wherein, in the stowed position of the post, the component protrudes upward of the upper plane of the platform.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevation view of a platform assembly, illustrating a platform, a post pivotably coupled to the platform in a deployed position, and a standoff pivotably coupled to the post in a use position, according to one embodiment;

FIG. 2 is a perspective view of the platform assembly, illustrating the platform, the post in the deployed position relative to the platform, and the standoff in the use position, according to one embodiment;

FIG. 3 is a top plan view of the platform assembly, illustrating the post in the deployed position and the standoff in the use position, according to one embodiment;

FIG. 4 is a side elevational view of the platform assembly, illustrating the platform, the post in the deployed position, and standoff in the use position, according to one embodiment;

FIG. 5 is a side elevational view of the platform assembly, illustrating the platform, the post in the deployed position, and the standoff in a retracted position, according to one embodiment;

FIG. 6 is a side elevational view of the platform assembly, illustrating the platform, the post in a stowed position, and the standoff in the retracted position, such that no portion of the post and no portion of the standoff is disposed above an upper plane defined by an upper surface of the platform, according to one embodiment;

FIG. 7 is a perspective view of the platform assembly, illustrating the platform, the post in the stowed position, and the standoff in the retracted position, according to one embodiment;

FIG. 8 is a top plan view of the platform assembly, illustrated the platform, the post in the stowed position, and the standoff in the retracted position, according to one embodiment;

FIG. 9 is an exploded perspective view of the platform assembly, illustrating the platform, a pivot pin, an insert that is configured to be received within a receiving area defined by the platform, the post, and the standoff pivotably coupled to the post, according to one embodiment;

FIG. 10 is a perspective view of an insert, illustrating opposing first and second lateral wings of the insert and a rear sloped portion that extends laterally between the first and second lateral wings, according to one embodiment;

FIG. 11 illustrates the insert that includes the first and second lateral wings, the rear sloped portion in a spatial spaced relationship with the insert, and a fastener that is configured to extend through the insert, according to one embodiment;

FIG. 12 is a cross-sectional view of the platform assembly of FIG. 8 taken at line XII-XII, illustrating the insert received within a receiving area defined by the platform of the platform assembly, according to one embodiment;

FIG. 13 is an enlarged view of area XIII of FIG. 12, illustrating the insert engaged with a portion of the interior structure of the platform that defines the receiving area, according to one embodiment;

FIG. 14 is an exploded perspective view of the post of the platform assembly and a plurality of components that are configured to be assembled with the post, according to one embodiment;

FIG. 15 is a perspective view of a platform assembly, illustrating a platform, a post in a deployed position relative to the platform, and a standoff in a use position relative to the post, according to one embodiment; and

FIG. 16 is a top plan view of the platform assembly of FIG. 15, illustrating the post in a stowed position and the standoff in a retracted position, according to one embodiment.

### DETAILED DESCRIPTION OF THE PREFERRED EMBODIMENTS

Additional features and advantages of the present disclosure will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

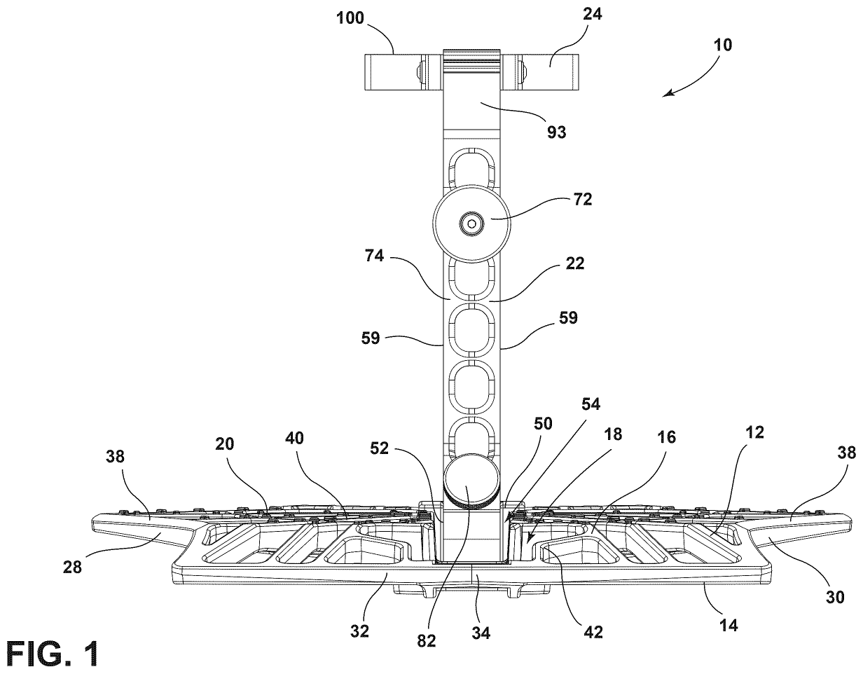

For purposes of description herein, the terms “upper,” “lower,” “right,” “left,” “lateral,” “rear,” “front,” “vertical,” “horizontal,” “upward,” “downward” and derivatives thereof shall relate to the disclosure as oriented in FIG. 1. Unless stated otherwise, the term “front” shall refer to closer to an intended viewer, and the term “rear” shall refer to further from the intended viewer. Unless stated otherwise, the term “forward” shall refer to toward the intended viewer and/or closer to the intended viewer based on the context. For example, the phrase “extending forward” shall be interpreted as extending toward the intended viewer, while a first element being “forward of” a second element shall refer to the first element being closer than the second element to the intended viewer. Unless stated otherwise, the term “rearward” shall refer to away from the intended viewer and/or further from the intended viewer based on the context. For example, the phrase “extending rearward” shall be interpreted as extending away from the intended viewer, while a first element being “rearward of” a second element shall refer to the first element being further than the second element from the intended viewer. Unless stated otherwise, the term “lateral” and derivatives thereof shall refer to left-right directions. Further, unless stated otherwise, the term “horizontal” shall refer to forward, rearward, left, right, and/or combinations thereof. However, it is to be understood that the disclosure may assume various alternative orientations, except where expressly specified to the contrary. It is also to be understood that the specific devices illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

For purposes of this disclosure, the term “coupled” (in all of its forms: couple, coupling, coupled, etc.) generally means the joining of two components (electrical or mechanical) directly or indirectly to one another. Such joining may be stationary or movable in nature. Such joining may be achieved with the two components (electrical or mechanical) and/or any additional intermediate members. Such joining may include members being integrally formed as a single unitary body with one another (i.e., integrally coupled) or may refer to the joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

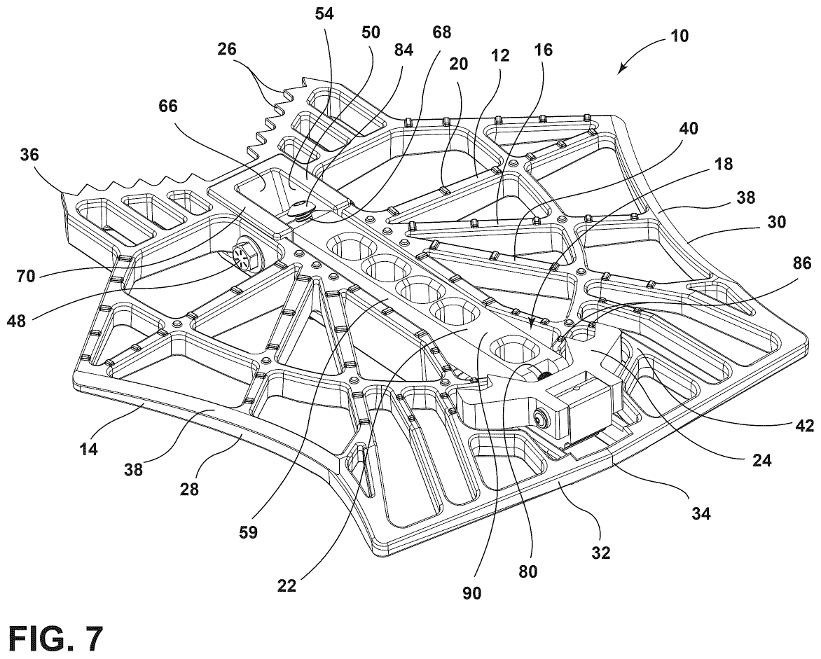

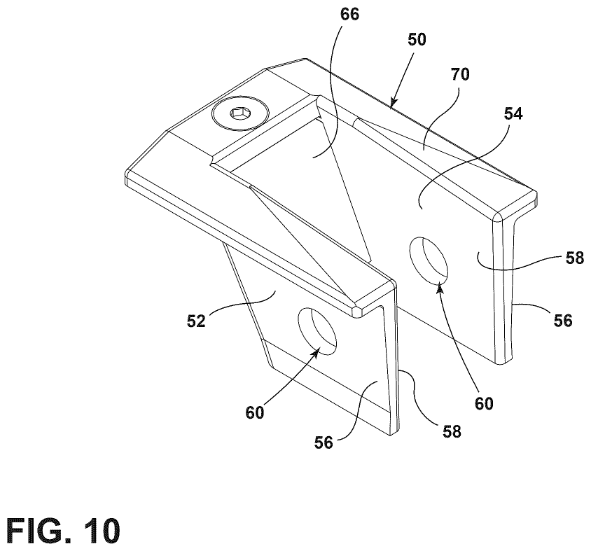

Referring now to FIGS. 1-16, a platform assembly 10 includes a platform 12. The platform 12 has an outer perimeter 14 that bounds an interior structure 16 that defines a receiving area 18. The platform 12 includes an upper surface 20 for supporting feet of a user. The upper surface 20 defines an upper plane of the platform 12. A post 22 is pivotably coupled with the platform 12 and is operable to pivot between the stowed position, wherein the post 22 is received within the receiving area 18, and the deployed position. A standoff 24 is pivotably coupled with the post 22 and is operable to pivot relative to the post 22 between the retracted position and the use position. In the stowed position of the post 22 and the retracted position of the standoff 24, no portion of the standoff 24 and no portion of the post 22 is positioned upward of the upper plane of the platform 12.

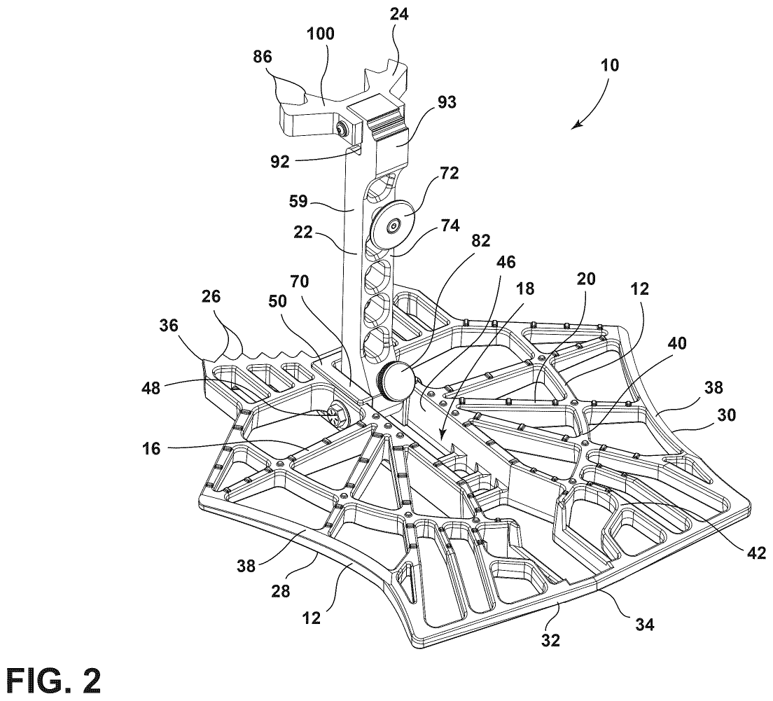

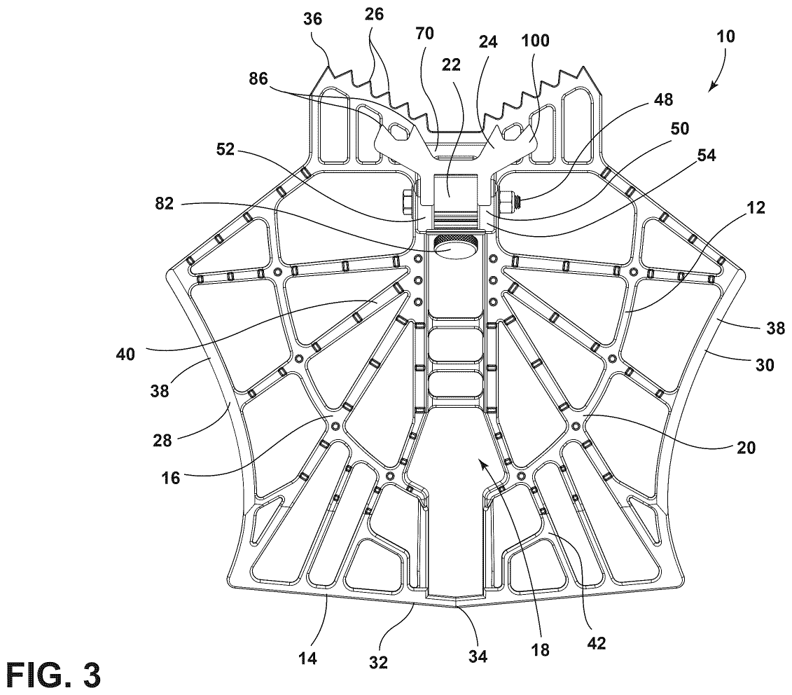

Referring now to FIGS. 1-4 and 9, the platform assembly 10 includes the platform 12. The platform 12 includes the outer perimeter 14, and the interior structure 16 extends inboard from the outer perimeter 14 of the platform 12. As illustrated in FIG. 3, the outer perimeter 14 of the platform 12 can define a plurality of teeth 26. In the illustrated embodiment, the plurality of teeth 26 are disposed along the outer perimeter 14 at the rear side of the platform 12. The plurality of teeth 26 of the platform 12 may be configured to be engaged with a tree to which the platform 12 is secured during use of the platform assembly 10. As illustrated in FIG. 3, the outer perimeter 14 includes first and second concave lateral side portions 28, 30. The first and second concave lateral side portions 28, 30 extend in concave fashion from a front portion 32 of the outer perimeter 14 rearward and terminate at laterally-outboard-most portions of the platform 12. In some embodiments, a front 34 of the platform 12 is a first distance in the fore-aft (forward-rearward) direction of the platform 12 from a rear 36 of the platform 12, and each of the first and second concave lateral side portions 28, 30 of the outer perimeter 14 extends a distance in the fore-aft direction that is greater than half of the first distance. In some embodiments, a portion of the first and/or second concave lateral side portions 28, 30 may have a beveled edge 38 at a junction between the outer perimeter 14 and the upper surface 20 of the interior structure 16 of the platform 12. For example, as illustrated in FIG. 2, a majority of the first concave lateral side portion 28 of the platform 12 is beveled where the upper surface 20 of the interior structure 16 meets the outer perimeter 14 of the platform 12. The concavity of the first and second concave lateral side portions 28, 30 of the outer perimeter 14, and the beveling thereof, may enhance traction for the feet (e.g., boots) of a user of the platform assembly 10, in various embodiments.

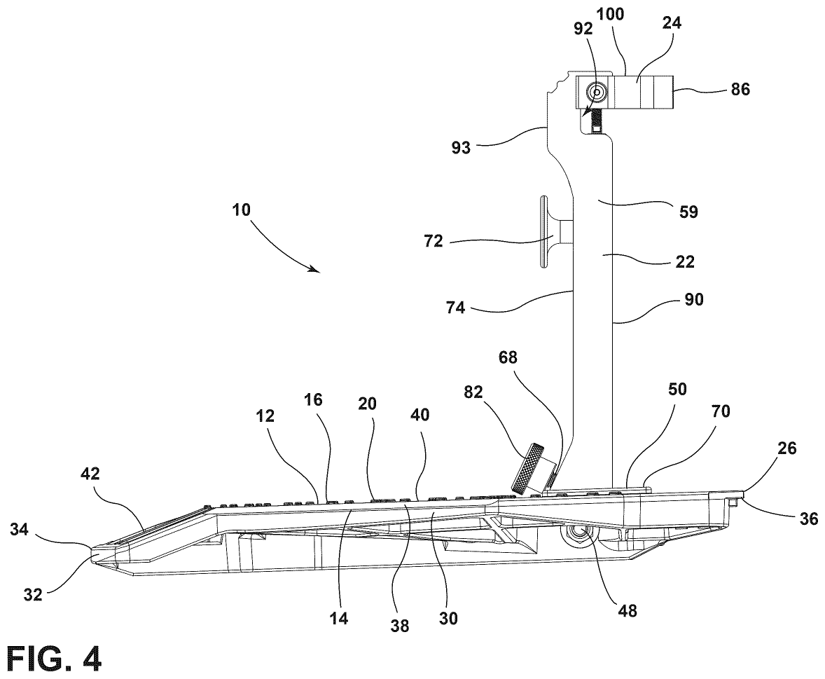

Referring still to FIGS. 1-4 and 9, the interior structure 16 of the platform 12 extends inboard from the outer perimeter 14. The interior structure 16 forms the upper surface 20 of the platform 12 that is configured to support the feet of the user in operation of the platform assembly 10. The upper surface 20 of the platform 12 defines the upper plane of the platform 12. The upper plane of the platform 12 may extend substantially horizontally, as illustrated in FIGS. 1 and 4.

In some embodiments, the upper surface 20 of the platform 12 may include a rear portion 40 and a front portion 42. For example, as illustrated in FIG. 4, the upper surface 20 of the platform 12 includes the rear portion 40 that defines the upper plane and the front portion 42 that angles downward as the front portion 42 extends forward from the rear portion 40 of the upper surface 20 toward the front 34 of the platform 12. As such, the front portion 42 of the upper surface 20 extends below the upper plane defined by the rear portion 40 of the upper surface 20 at an angle relative to the upper plane. In various implementations, the front portion 42 being angled relative to the rear portion 40, as illustrated in FIG. 4, may enhance the comfort of the user by providing an angled surface for the user's feet to rest upon during use of the platform assembly 10.

Referring still to FIGS. 1-4 and 9, in various embodiments, the platform 12 defines the receiving area 18. As illustrated in FIG. 3, in various embodiments, the receiving area 18 is disposed along the lateral-center of the platform 12. As described further herein, in various implementations, the receiving area 18 defined by the interior structure 16 of the platform 12 may receive the post 22 in the stowed position of the post 22 and/or the standoff 24 in the retracted position of the standoff 24.

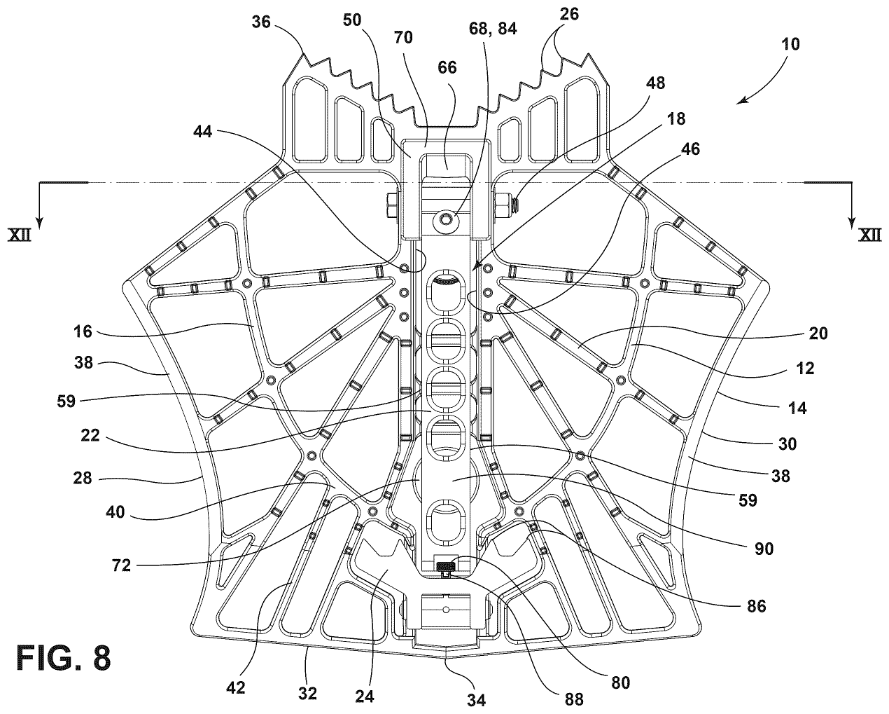

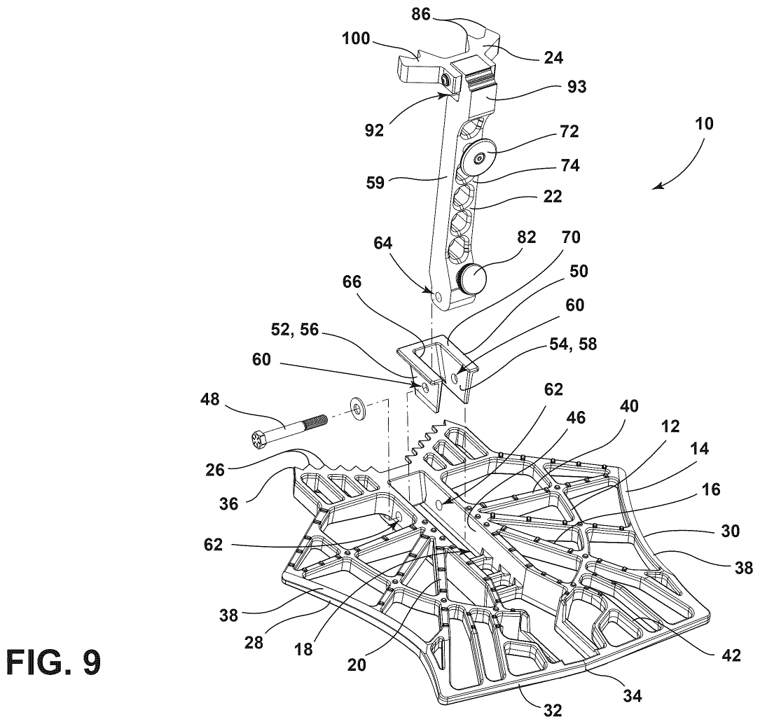

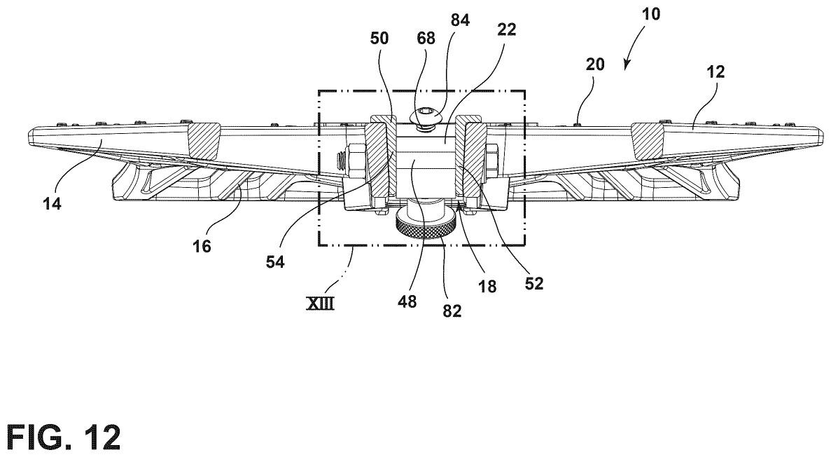

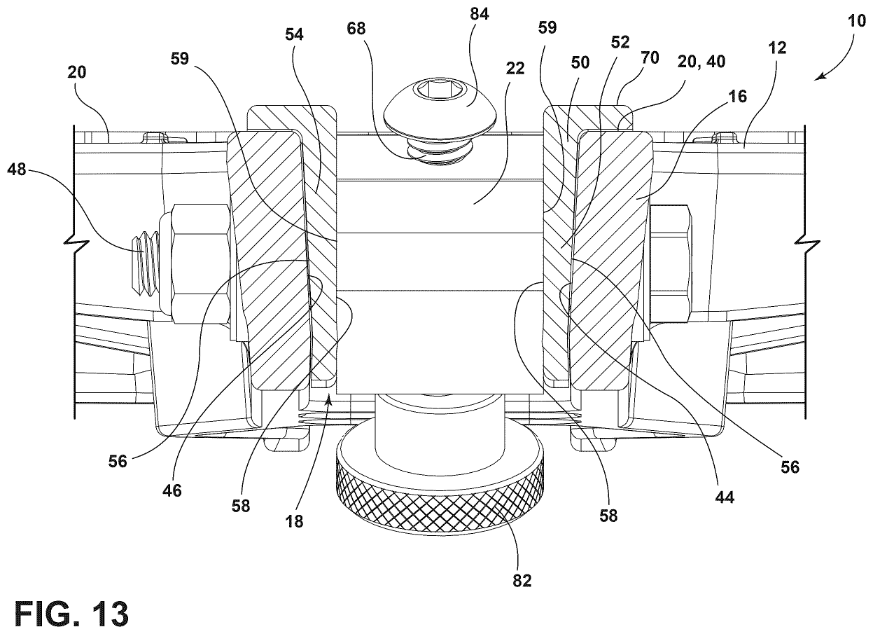

Referring now to FIGS. 8, 9, 12, and 13, in various embodiments, a portion of the interior structure 16 of the platform 12 that defines the receiving area 18 includes opposing first and second laterally-inboard facing surfaces 44, 46. As illustrated in FIGS. 12 and 13, at least a portion of the first laterally-inboard facing surface 44 may angle laterally inboard as the at least a portion of the first laterally-inboard facing surface 44 extends downward. Further, at least a portion of the second laterally-inboard facing surface 46 may angle laterally inboard as the at least a portion of the second laterally-inboard facing surface 46 extends downward. This angling of the opposing first and second laterally-inboard facing surfaces 44, 46 is illustrated in FIG. 13. In various implementations, the post 22 may be disposed between the opposing first and second laterally-inboard facing surfaces 44, 46, as illustrated in FIG. 13. Further, as illustrated in FIGS. 9, 12, and 13, a pivot pin 48 may extend through the portion of the interior structure 16 that includes the opposing first and second laterally-inboard facing surfaces 44, 46. The pivot pin 48 may be configured to allow pivotal movement of the post 22 relative to the platform 12, as described further herein.

Referring now to FIGS. 8-13, in some embodiments, the platform assembly 10 may include an insert 50. The insert 50 may be configured to be engaged with the platform 12. In various implementations, the insert 50 may extend into the receiving area 18 defined by the interior structure 16 of the platform 12 while engaged with the platform 12, as illustrated exemplarily in FIGS. 12 and 13. In various embodiments, the insert 50 includes opposing first and second lateral wings 52, 54. The opposing first and second lateral wings 52, 54 may each include a laterally-outboard facing surface 56 and an interior side surface 58. The interior side surfaces 58 of the first and second lateral wings 52, 54 may face laterally inboard toward each other. In various embodiments, the post 22 may be disposed between the first and second lateral wings 52, 54 of the insert 50, and the interior side surfaces 58 of the first and second lateral wings 52, 54 may face and/or be in contact with the post 22 while the insert 50 is engaged with the platform 12.

As illustrated in FIG. 13, in various embodiments, the interior side surface 58 of the first lateral wing 52 may be substantially parallel to the interior side surface 58 of the second lateral wing 54 when the insert 50 is engaged with the platform 12. In some embodiments, the laterally-outboard facing surface 56 of the first lateral wing 52 and the laterally-outboard facing surface 56 of the second lateral wing 54 may be angled to respectively complement the angles of the first and second laterally-inboard facing surfaces 44, 46 of the portion of the interior structure 16 of the platform 12 that defines the receiving area 18. As illustrated in FIG. 13, the first and second lateral wings 52, 54 taper in a narrowing fashion as the first and second lateral wings 52, 54 extend downward. This taper is due to the laterally-outboard facing surfaces 56 of the first and second lateral wings 52, 54 extending in an angling fashion relative to the interior side surfaces 58. As illustrated, the angles correspond with, or complement, the angles of the first and second laterally-inboard facing surfaces 44, 46 of the portion of the platform 12 that defines the receiving area 18. This allows for the laterally-outboard facing surfaces 56 of the first and second lateral wings 52, 54 to fit snugly against the first and second laterally-inboard facing surfaces 44, 46 of the portion of the platform 12 defines the receiving area 18. Further, because of the taper of the first and second lateral wings 52, 54 of the insert 50, the interior side surfaces 58 are able to be oriented substantially parallel to each other and parallel to the lateral sides 59 of the post 22 that interface with the interior side surfaces 58 of the first and second lateral wings 52, 54 of the insert 50.

As illustrated in FIG. 9, the first and second lateral wings 52, 54 of the insert 50 may define apertures 60 that extend laterally through the first and second lateral wings 52, 54. While the insert 50 is engaged with the platform 12, the apertures 60 defined by the first and second lateral wings 52, 54 may be aligned with corresponding apertures 62 defined by the portion of the platform 12 that defines the receiving area 18, as well as an aperture 64 that extends laterally through the post 22. As illustrated in FIG. 9, the pivot pin 48 is configured to extend through the aligned apertures 62, 60, 64 of the platform 12, the first and second lateral wings 52, 54 of the insert 50, and the post 22 to pivotably couple the post 22 with the platform 12. In this arrangement, the first and second lateral wings 52, 54 of the insert 50 may replace washers that would extend laterally between and provide angle compensation for the post 22 and the angled first and second laterally-inboard facing surfaces 44, 46 of the portion of the platform 12 defines the receiving area 18. The first and second lateral wings 52, 54 of the post 22 being connected to each other as part of the insert 50 may advantageously provide a poka-yoke solution for assembly of the platform assembly 10 relative to utilizing two angled washers that would need to be individually assembled and oriented rotationally to compensate for the dissonant angles between the lateral sides 59 of the post 22 and the first and second laterally-inboard facing surfaces 44, 46 of the platform 12.

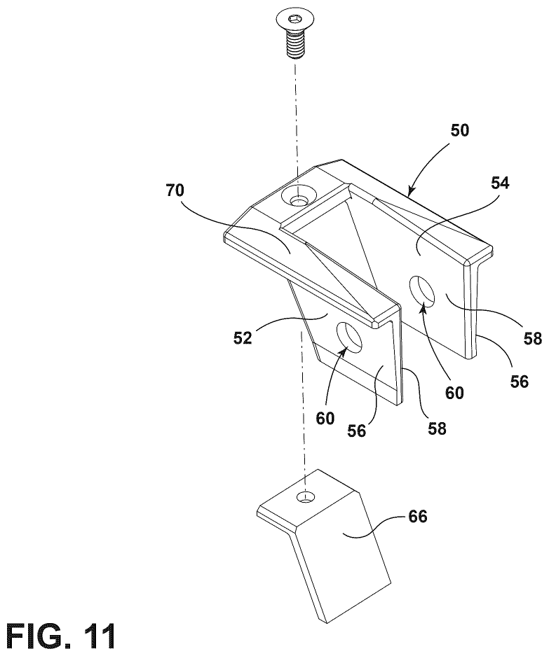

Referring still to FIGS. 8-13, in various embodiments, a rear sloped portion 66 may extend between the first and second lateral wings 52, 54 of the insert 50. In some embodiments, the rear sloped portion 66 may be a portion of the insert 50. In the embodiment illustrated in FIG. 11, the rear sloped portion 66 is shown as a component that is distinct from the insert 50 that includes the first and second lateral wings 52, 54. In an exemplary implementation, the insert 50 may be formed of a first material (e.g., rubber, plastic, etc.), and the rear sloped portion 66 may be formed of a second material that is harder than the first material (e.g., metal, such as steel). A variety of types of materials are contemplated. As described further herein, the rear sloped portion 66 may be configured to be engaged by a threaded shaft 68 that extends within and is engaged with the post 22 to set an angle of the post 22 relative to the platform 12 in the deployed position of the post 22.

In the embodiments illustrated in FIGS. 8-13, the insert 50 includes the first and second lateral wings 52, 54 that define the apertures 60 for receiving the pivot pin 48 therethrough and a flange 70 that extends outward from the first and second lateral wings 52, 54. As illustrated in FIG. 13, the flange 70 is configured to rest upon the upper surface 20 of the interior structure 16 of the platform 12. In this way, the flange 70 helps maintain the engagement between the platform 12 and the insert 50.

Referring now to FIGS. 4, 9, and 12, in various embodiments, the pivot pin 48 that extends through the platform 12 and the post 22 to allow the post 22 to pivot relative to the platform 12 may be positioned vertically lower than the upper surface 20 of the platform 12. As illustrated exemplarily in FIG. 4, in some embodiments, the pivot pin 48 may be positioned vertically lower than at least a portion of at least one of the plurality of teeth 26 of the platform 12.

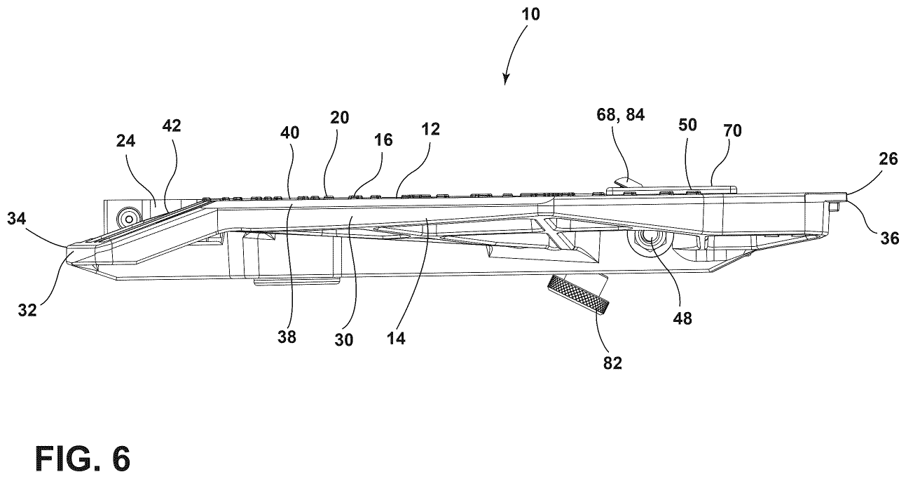

Referring now to FIGS. 1-9 and 14-16, the platform assembly 10 includes the post 22 that is pivotably coupled with the platform 12. In various embodiments, the post 22 is operable to pivot between a stowed position, as illustrated exemplarily in FIGS. 6-8 and 16, and the deployed position, as illustrated exemplarily in FIGS. 1-5 and 15. In various embodiments, the pivot pin 48 extending through the post 22 may allow for pivotal movement of the post 22 relative to the platform 12 between the stowed and deployed positions. In various implementations, in the stowed position of the post 22, no portion of the post 22 is positioned upward of the upper plane of the platform 12, as described further herein.

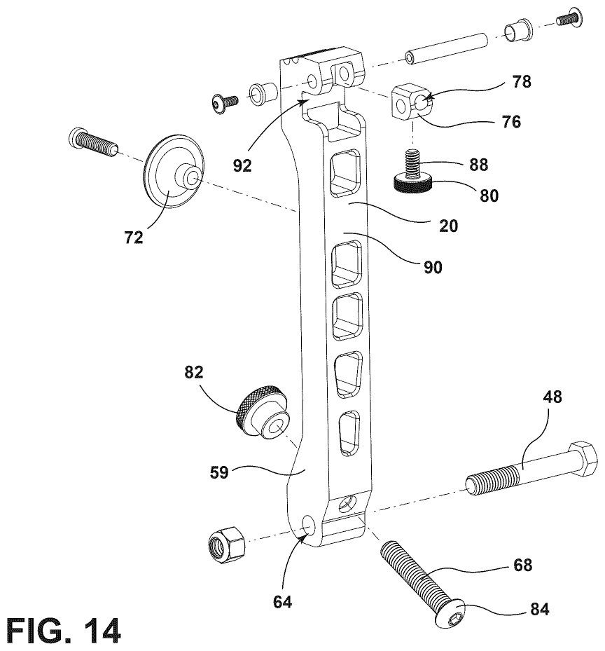

As illustrated in FIG. 14, a plurality of components that are distinct from the post 22 may be coupled to the post 22 in the assembled condition of the platform assembly 10. For example, a cleat 72 may be fastened to a front side 74 of the post 22 via a fastener, the pivot pin 48 may extend through the aperture 64 defined by the post 22, a receiver 76 that defines a depression 78 may be coupled to the post 22, and/or the threaded shaft 68 may extend through the post 22. The receiver 76 that defines the depression 78 may be configured to interact with a lock 80 that is configured to selectively fix the orientation of the standoff 24 of the platform assembly 10 relative to the post 22, as described further herein. The threaded shaft 68 may be coupled to the post 22 and to an adjustment knob 82, such that rotation of the adjustment knob 82 adjusts a distance that the threaded shaft 68 extends outward from the post 22. In various embodiments, the threaded shaft 68 is coupled to the post 22 and the adjustment knob 82, such that rotation of the adjustment knob 82 adjusts a distance that the threaded shaft 68 extends outward from the post 22. This, in turn, determines the angle of the post 22 relative to the platform 12 in the deployed position of the post 22 due to contact between a head 84 of the threaded shaft 68 and the rear sloped portion 66 that extends laterally between the first and second lateral wings 52, 54 of the insert 50. In various embodiments, the post 22 may be formed of a first material (e.g., aluminum), the receiver 76 that defines the depression 78 may be formed of a second material (e.g., steel), and the second material may be harder than the first material.

Referring now to FIG. 6, in some embodiments, a component that is distinct from the post 22, coupled with the post 22, and configured to pivot with the post 22 between the stowed and deployed positions may protrude upward of the upper plane of the platform 12 in the stowed position of the post 22. For example, as illustrated in FIG. 6, the head 84 of the threaded shaft 68 that is coupled to the post 22 and to the adjustment knob 82 extends upward of the upper plane of the platform 12. As such, no portion of the post 22 is positioned upward of the upper plane of the platform 12 in the exemplary embodiment, but a component that is coupled to the post 22 extends above of the upper plane of the platform 12.

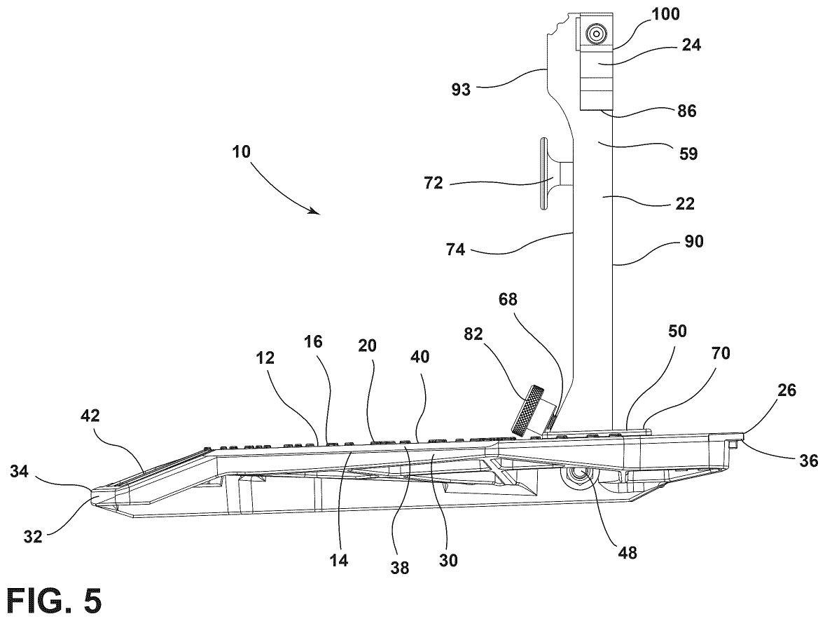

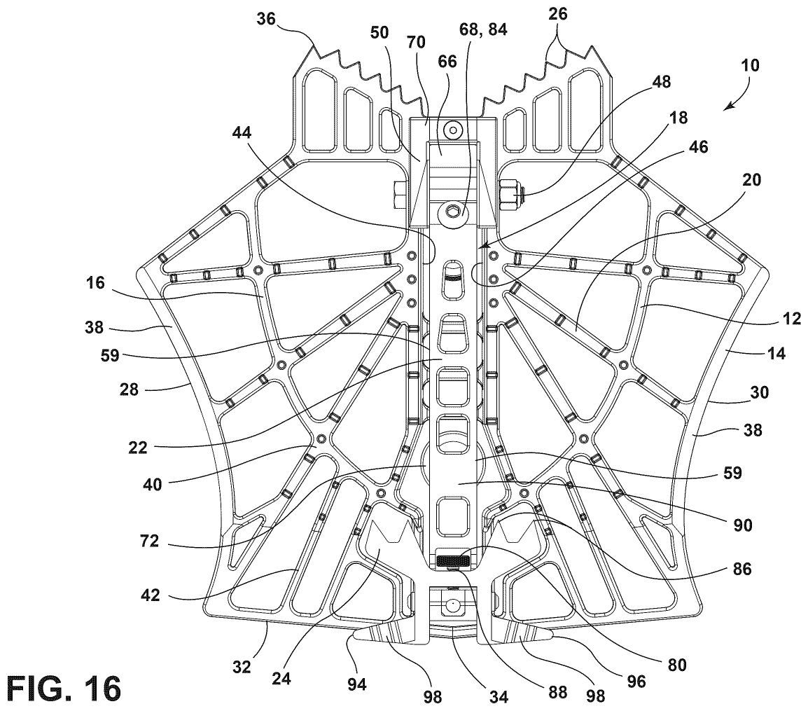

Referring now to FIGS. 1-9 and 14-16, the platform assembly 10 includes the standoff 24. The standoff 24 may extend outward from the post 22 of the platform assembly 10. In various embodiments, the standoff 24 may be pivotably coupled to the post 22 of the platform assembly 10. In some embodiments, the standoff 24 may be operable to pivot relative to the post 22 between the retracted position, as illustrated exemplarily in FIGS. 5-8 and 16, and the use position, as illustrated in FIGS. 1-4 and 15. The standoff 24 may include a plurality of teeth 86 that are configured to be engaged with the tree to which the platform assembly 10 is coupled in operation of the platform assembly 10 by a user. In various implementations, the lock 80 may be operably coupled with the standoff 24 and configured to selectively lock 80 the standoff 24 in the use position and/or the retracted position. As illustrated in FIGS. 8 and 16, the lock 80 may include a pin 88 that is configured to be received within the depression 78 defined by the receiver 76 that is coupled to the post 22 of the platform assembly 10. The pin 88 may be threaded, in some embodiments, such that rotation of the pin 88 by the user allows for extension and retraction of the pin 88 into and out of the depression 78, thereby allowing the standoff 24 to be locked and unlocked from the use position.

As illustrated in FIGS. 4 and 5, the rear side 90 of the post 22 includes a recess 92 that is disposed relatively nearer to the pivot pin 48 than the portion of the post 22 about which the standoff 24 pivots between the use and retracted positions. As illustrated in FIG. 5, in the retracted position of the standoff 24, a portion of the standoff 24 is received within the recess 92 defined by the rear side 90 of the post 22. This allows the standoff 24 to have a minimalized profile while in the retracted position. As illustrated in FIGS. 4 and 5, the front side 74 of the post 22 bulges forward along the portion of the post 22 in which the rear side 90 of the post 22 is recessed. This bulge 93 maintains a thickness to the post 22 that is suitable for the strength requirements of the post 22 despite the presence of the recess 92.

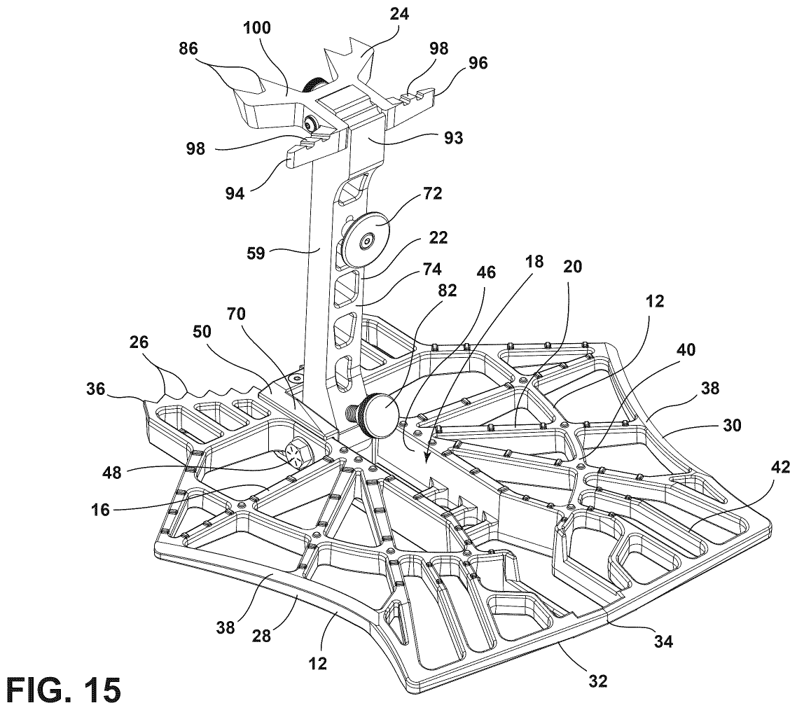

As illustrated in FIGS. 15 and 16, in some embodiments, the standoff 24 includes first and/or second steps 94, 96 that extend laterally-outboard away from the post 22. The steps may be configured to provide a foothold for a user of the platform assembly 10. The first and/or second steps 94, 96 may have an engagement surface 98 that is angled relative to a top surface 100 of the standoff 24. As illustrated in FIG. 15, in the use position of the standoff 24, the top surface 100 is angled relative to the upper plane of the platform 12. In the illustrated embodiment, the standoff 24 is pivoted more than 90° from the retracted position to the stowed position, such that the top surface 100 of the standoff 24 is angled relative to the upper plane of the platform 12. The engagement surface 98 of the first and/or second steps 94, 96 of the standoff 24 may be angled relative to the top surface 100 of the standoff 24, such that, in the use position of the standoff 24, the engagement surface 98 of the first and/or second steps 94, 96 are closer to parallel with the upper plane than the top surface 100 of the standoff 24 is relative to the upper plane.

As illustrated in FIG. 16, in some embodiments, in the stowed position of the post 22 and the retracted position of the standoff 24, a portion of the standoff 24 may extend forward beyond the front 34 of the platform 12. For example, in the embodiment illustrated in FIG. 16, portions of the first and second steps 94, 96 of the standoff 24 extend forward beyond the front 34 of the platform 12.

Referring now to FIGS. 1-8, in various embodiments, in the stowed position of the post 22 and the retracted position of the standoff 24, no portion of the standoff 24 and/or no portion of the post 22 is positioned upward of the upper plane of the platform 12. For example, as illustrated in FIG. 6, wherein the post 22 is in the stowed position and the standoff 24 is in the retracted position, no portion of the post 22 and no portion of the standoff 24 is positioned upward of the upper plane of the platform 12. In various embodiments, in the stowed position of the post 22 and retracted position of the standoff 24, the standoff 24 and the post 22 are positioned wholly downward of the upper plane of the platform 12. In various embodiments, the entirety of the standoff 24 is disposed downward of the upper plane of the platform 12. As illustrated in FIG. 8, in some implementations, in the stowed position of the post 22 and the retracted position of the standoff 24, a first portion of the standoff 24 is aligned, with respect to the forward-rearward directions, with the rear portion 40 of the upper surface 20, and a second portion of the standoff 24 is aligned, with respect to the forward-rearward directions, with the front portion 42 of the upper surface 20. As illustrated in FIG. 6, the second portion of the standoff 24 that is aligned with the front portion 42 of the upper surface 20 may extend upward of the front portion 42 of the upper surface 20. However, in various embodiments, the upper plane that is defined by the rear portion 40 of the upper surface 20 of the platform 12 is not reached by the standoff 24 in the upward direction.

In operation of an exemplary implementation of the platform assembly 10, a user may initially have the platform assembly 10 arranged such that the post 22 is in the stowed position and the standoff 24 is in the retracted position. This minimizes the profile of the platform assembly 10, which allows for optimal packability of the platform assembly 10. Upon reaching and climbing a tree within which the user plans to utilize the platform assembly 10, the user may pivot the post 22 from the stowed position to the deployed position and pivot the standoff 24 from the retracted position to the use position. The user may then utilize the lock 80 that is coupled to the standoff 24 to fix the orientation of the standoff 24 relative to the post 22.

After strapping the platform assembly 10 to the tree, the user may turn the adjustment knob 82 that is coupled to the threaded shaft 68 in order to adjust the angle of the platform 12 relative to the post 22. As the adjustment knob 82 is disposed above the upper plane defined by the upper surface 20 of the platform 12 in the deployed position of the post 22, the user may conveniently adjust the adjustment knob 82 by hand or with a foot. As the adjustment knob 82 is turned, the threaded shaft 68 either protrudes farther from the post 22 or is drawn farther into the post 22. This adjustment of the distance that the threaded shaft 68 extends from the post 22 will determine where on the rear sloped portion 66 that extends between the first and second lateral wings 52, 54 of the insert 50 the head 84 of the threaded shaft 68 coincides, thereby dictating the angle of the platform 12 relative to the post 22.

What is claimed is:

1. A platform assembly, comprising:
a platform having an outer perimeter that bounds an interior structure that defines a receiving area, the platform having an upper surface for supporting feet of a user, wherein the upper surface defines an upper plane of the platform;
a post pivotably coupled with the platform and operable to pivot between a stowed position, wherein the post is received within the receiving area, and a deployed position; and
a standoff pivotably coupled with the post and operable to pivot relative to the post between a retracted position and a use position, wherein, in the stowed position of the post and the retracted position of the standoff, no portion of the standoff is positioned upward of the upper plane of the platform.

2. The platform assembly of claim 1, further comprising:
a component that is distinct from the post, coupled to the post, and configured to pivot with the post between the stowed position and the deployed position, wherein, in the stowed position of the post, the component protrudes upward of the upper plane of the platform.

3. The platform assembly of claim 2, wherein the component is a threaded shaft that is coupled to the post and to an adjustment knob, such that rotation of the adjustment knob adjusts a distance that the threaded shaft extends outward from the post.

4. The platform assembly of claim 2, further comprising:
a pivot pin that extends through a portion of the platform and extends through the post to allow the post to pivot relative to the platform about the pivot pin, wherein the platform includes a plurality of teeth that are configured to engage a tree, and wherein the pivot pin is positioned vertically lower than a portion of at least one of the plurality of teeth.

5. The platform assembly of claim 4, wherein the upper surface of the platform includes a rear portion that defines the upper plane and a front portion that angles downward as the front portion extends forward from the rear portion of the upper surface toward a front of the platform, such that the front portion of the upper surface extends below the upper plane at an angle relative to the upper plane, and wherein, in the stowed position of the post and the retracted position of the standoff, a first portion of the standoff is aligned, with respect to the forward-rearward directions, with the rear portion of the upper surface, and a second portion of the standoff is aligned, with respect to the forward-rearward direction, with the front portion of the upper surface.

6. The platform assembly of claim 1, further comprising:
an insert that is configured to be engaged with the platform and includes opposing first and second lateral wings, wherein a portion of the post is disposed between the first and second lateral wings; and
a pivot pin that extends through the platform, the first and second lateral wings, and the portion of the post, wherein the pivot pin is configured to allow pivotal movement of the post relative to the insert and the platform between the stowed and deployed positions.

7. The platform assembly of claim 6, wherein the first lateral wing of the insert includes an interior side surface that faces laterally-inboard toward the post, the second lateral wing of the insert includes an interior side surface that faces laterally-inboard toward the post, and the interior side surface of the first lateral wing is substantially parallel to the interior side surface of the second lateral wing when the insert is engaged with the platform.

8. The platform assembly of claim 7, wherein a portion of the interior structure of the platform that defines the receiving area includes opposing first and second laterally-inboard facing surfaces, at least a portion of the first laterally-inboard facing surface angles radially inboard as the at least a portion of the first laterally-inboard facing surface extends downward, and at least a portion of the second laterally-inboard facing surface angles radially inboard as the at least a portion of the second laterally-inboard facing surface extends downward.

9. The platform assembly of claim 8, wherein the first lateral wing of the insert includes a laterally-outboard facing surface and the second lateral wing of the insert includes a laterally-outboard facing surface, and wherein the laterally-outboard facing surfaces of the first and second lateral wings are angled to complement the angles of the first and second laterally-inboard facing surfaces of the portion of the interior structure of the platform, respectively.

10. The platform assembly of claim 7, further comprising:
threaded shaft that is coupled to the post and to an adjustment knob, such that rotation of the adjustment knob adjusts a distance that the threaded shaft extends outward from the post, which determines the angle of the post relative to the platform in the deployed position of the post due to contact between a head of the threaded shaft and a rear sloped portion that extends laterally between the first and second lateral wings of the insert.

11. The platform assembly of claim 10, wherein at least a portion of the adjustment knob is positioned upward of the upper plane defined by the upper surface of the platform in the deployed position of the post.

12. A platform assembly, comprising:
a platform having an outer perimeter that bounds an interior structure that defines a receiving area;
an insert that is engaged with the platform and that includes opposing first and second lateral wings that extend within the receiving area defined by the interior structure of the platform;
a post that extends within the receiving area laterally between the first and second lateral wings of the insert; and
a pivot pin that extends through the platform, the post, and the first and second lateral wings of the insert, wherein the pivot pin allows the post to pivot relative to the platform between a stowed position and a deployed position.

13. The platform assembly of claim 12, wherein the first lateral wing of the insert includes an interior side surface that faces laterally-inboard toward the post, the second lateral wing of the insert includes an interior side surface that faces laterally-inboard toward the post, and the interior side surface of the first lateral wing is substantially parallel to the interior side surface of the second lateral wing when the insert is engaged with the platform.

14. The platform assembly of claim 13, wherein a portion of the interior structure of the platform that defines the receiving area includes opposing first and second laterally-inboard facing surfaces, at least a portion of the first laterally-inboard facing surface angles laterally inboard as the at least a portion of the first laterally-inboard facing surface extends downward, and at least a portion of the second laterally-inboard facing surface angles laterally inboard as the at least a portion of the second laterally-inboard facing surface extends downward.

15. The platform assembly of claim 14, wherein the first lateral wing of the insert includes a laterally-outboard facing surface and the second lateral wing of the insert includes a laterally-outboard facing surface, and wherein the laterally-outboard facing surfaces of the first and second lateral wings are angled to complement the angles of the first and second laterally-inboard facing surfaces of the portion of the interior structure of the platform, respectively.

16. The platform assembly of claim 12, further comprising:
a standoff that extends outward from the post.

17. The platform assembly of claim 16, wherein the standoff is a standoff pivotably coupled with the post and operable to pivot relative to the post between a retracted position and a use position.

18. The platform assembly of claim 17, wherein the platform includes an upper surface that defines an upper plane of the platform, and, in the stowed position of the post and the retracted position of the standoff, the upper plane is positioned upward of the post and the standoff.

19. A platform assembly, comprising:
a platform having an outer perimeter that bounds an interior structure that defines a receiving area, the platform having an upper surface for supporting feet of a user, wherein the upper surface defines an upper plane of the platform;
an insert that is engaged with the platform and that includes opposing first and second lateral wings that extend within the receiving area defined by the interior structure of the platform;
a post that extends within the receiving area laterally between the first and second lateral wings of the insert;
a standoff pivotably coupled with the post and operable to pivot relative to the post between a retracted position and a use position; and
a pivot pin that extends through the platform, the post, and the first and second lateral wings of the insert, wherein the pivot pin allows the post to pivot relative to the platform between a stowed position, in which the post is received within the receiving area, and a deployed position, and wherein, in the stowed position of the post and the retracted position of the standoff, no portion of post and no portion of the standoff is positioned upward of the upper plane of the platform.

20. The platform assembly of claim 19, further comprising:
a component that is distinct from the post, coupled to the post, and configured to pivot with the post between the stowed position and the deployed position, wherein, in the stowed position of the post, the component protrudes upward of the upper plane of the platform.
